(19) United States
(12) Patent Application Publication
(10) Pub. No.: US 2006/0104166 A1
(43) Pub. Date: May 18, 2006

(54) Combination of lens and lens holder and optical pickup unit having the same

(75) Inventor: Ga-Lane Chen, Fremont, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/265,573

(22) Filed: Nov. 2, 2005

(30) Foreign Application Priority Data
Nov. 12, 2004 (CN) 2004100522671

(51) Int. Cl. G11B 7/00

(52) U.S. Cl. 369/44.14

(57) ABSTRACT

This invention provides a combination of an optical element and a holder for holding the optical element and an optical pickup unit including the combination. The optical pickup unit used in an optical storage system includes a light source, a focus device, and an optical detector. The light source generates a light beam. The focus device includes an objective lens for focusing the light beam to an optical disk, and a holder holding the objective lens. The objective lens and the holder are integrated together. The optical detector receives a return light beam reflected from the optical disk.

### BACKGROUND

1. Field of the Invention

The present invention generally relates to optical elements and related holders therefor which are used in optical storage systems, and more particularly to a combination of a lens and a related lens holder for use in an optical pickup device.

2. Related Art

A typical optical disk storage system is for recording information into an optical disk, and reading information stored in the optical disk, by means of a laser beam. The optical disk storage system generally includes an optical pickup unit movably arranged under the optical disk. In a reading operation, the optical pickup unit generates a converged laser beam that is incident on the optical disk. The optical pickup unit then receives a return laser beam reflected by the optical disk, and converts the return laser beam into electrical signals containing data recorded on the optical disk.

Referring to FIG. 4, a conventional optical pickup unit is shown. The optical pickup unit 80 includes a laser 81, an optical detector 82, a splitter 83, and an objective lens 84. A laser beam (not labeled) emitted from the laser 81 passes through the splitter 83 and is incident on the objective lens 84. The objective lens 84 focuses the incident laser beam into a converged light spot on a recording layer (not shown) of an optical disk (not labeled). Then the recording layer reflects the incident laser beam as a corresponding return laser beam. The return laser beam sequentially passes though the objective lens 84 and the splitter 83, and is then received by the optical detector 82. The optical detector 82 converts the received return laser beam into electrical signals containing data stored in the optical disc, and servo signals for adjusting positions of the objective lens 84. In a word, the data and servo signals can be obtained by detecting the reflection of the light spot on the optical disk.

A size of the light spot may vary depending on different disk formats. For example, a diameter of the light spot is generally 1.7 μm in the case of a CD format, and 1.08 μm in the case of a DVD format. In order to obtain higher storage capacity for a next generation high-density optical disk, the diameter of the light spot has to be controlled to be much smaller. This trend is steadily causing standard requirements of optical performance of optical pickup units to become more and more stringent. For example, the wave front aberration of an optical pickup unit in a next generation high-density optical storage system is required to be no more than 1/100. One determining factor of wave front aberration is associated with the objective lens and a lens holder for holding the objective lens.

FIG. 5 shows an objective lens 72, and a typical lens holder 74 for holding the objective lens 72. The objective lens 72 is made of a transparent resin material, and has a flange 720 formed at an outer circumference thereof. The lens holder 74 has a through hole 740, and a stepped portion 742 surrounding the through hole 740 for receiving the objective lens 72. The stepped portion 742 has a mounting surface 744, and three cutouts 746 evenly spaced apart from each other. In assembly, the objective lens 72 is received in the stepped portion 742 of the lens holder 74, with the flange 720 of the objective lens 72 resting on the mounting surface 744. An adhesive (not shown) is applied and cured in the cutouts 746.

However, there are some shortcomings of the above-mentioned structure in terms of securing the objective lens 72 to the lens holder 74 via the adhesive. First, the objective lens 72 may be deflected and/or displaced when a bonding strength between the objective lens 72 and the lens holder 74 becomes weakened and is not strong enough to secure the objective lens 72 in position. In such case, the cured adhesive may become softened and deformed. Second, it is difficult to apply the adhesive into the cutouts 746 without contamination of an incident surface of the objective lens 72. If contamination occurs, optical aberrations such as the above-described wave front aberration may be induced or magnified.

Therefore, a hitherto unaddressed need exists in the industry to address aforementioned deficiencies and inadequacies.

### SUMMARY

One embodiment provides a combination of an optical element and a holder for holding the optical element, for use in an optical storage system. The holder includes a hole, and the optical element is integrally formed with the holder, with a portion of the optical element occupying part of the hole, and the optical element and the holder are formed of essentially the same material.

Another embodiment provides an optical pickup unit for an optical disk storage system. The optical pickup unit includes a light source, a focus device, and an optical detector. The light source generates a light beam. The focus device includes an objective lens for focusing the light beam to an optical disk, and a holder holding the objective lens. The objective lens and the holder are integrated together. The optical detector receives a return light beam reflected from the optical disk.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic view showing an arrangement of optical elements of an optical pickup unit according to a preferred embodiment of the present invention, and also showing essential optical paths thereof;

FIG. 2 is an isometric view of a combination of an objective lens and a lens holder of FIG. 1, together with a mounting wall;

FIG. 3 is a cross-sectional view of FIG. 2, taken along line III-III thereof;

FIG. 4 is a schematic view showing a conventional optical pickup unit, and also showing essential optical paths thereof; and

FIG. 5 is an isometric view of a conventional objective lens and a related lens holder.

### DETAILED DESCRIPTION OF PREFERRED EMBODIMENTS

Hereinafter, an exemplary embodiment of a holder for holding an optical element, for example an objective lens, and an exemplary embodiment of an optical pickup unit for an optical disk storage system having the holder will be described in detail with reference to the accompanying drawings.

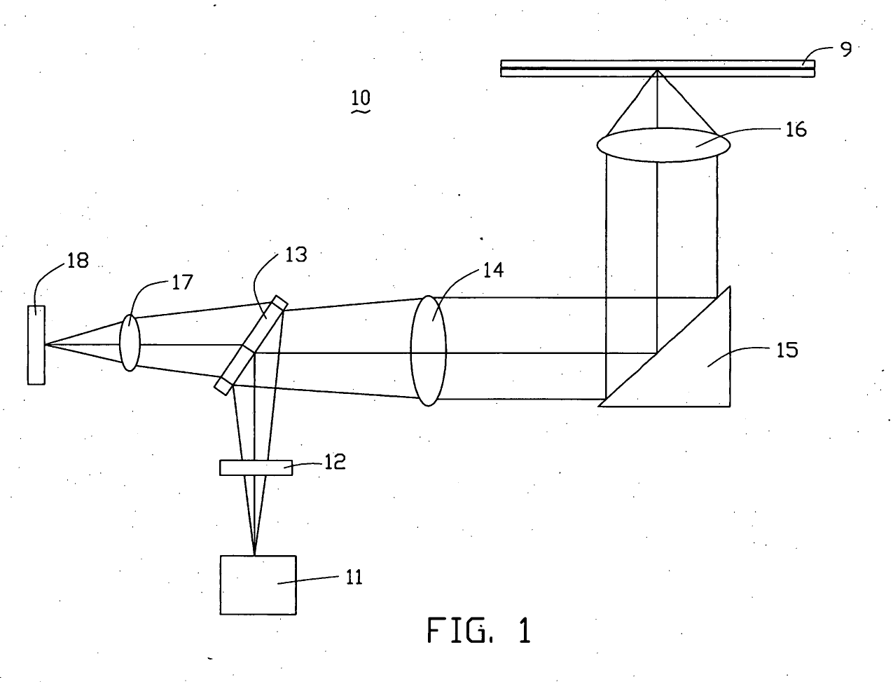

Referring to FIG. 1, an optical pickup unit 10 for an optical disk storage system is illustrated. The optical pickup unit 10 includes a light source 11, a diffraction element 12, an optical splitter 13, a collimator 14, a reflector 15, an objective lens 16, a cylindrical lens 17, and an optical detector 18. A semiconductor laser can be used as the light source 11 for generating a light beam. The diffraction element 12 is located next to the light source 11, for splitting the light beam emitted from the light source 11 into a primary light beam and two secondary light beams. Only the primary beam is focused and used for recording/reading information onto/from an optical disk 9. The secondary light beams are used for tracking tracks on the optical disk 9.

One portion of the light beams emitted from the diffraction element 12 passes through the optical splitter 12, and is directed by the optical splitter 12 to be incident on the cylindrical lens 17. The light beams that are incident on the cylindrical lens 17 pass through the cylindrical lens 17, and are received by the optical detector 18. The optical detector 18 instantly controls and adjusts an output power of the light source 11 according to an intensity of the received light beams. The other portion of the light beams emitted from the diffraction element 12 is reflected by the optical splitter 12, and is directed by the optical splitter 12 to be incident on the collimator 14, whereby the reflected light beams are converted into parallel light beams. The parallel light beams are reflected by the reflector 15 to be incident on the objective lens 16. The objective lens 16 may be an aspherical lens or a diffraction optical element, for focusing the parallel light beams on the optical disk 9. A recording layer of the optical disk 9 reflects the incident light beams as corresponding return light beams. The return light beams sequentially pass through the objective lens 16, the reflector 15, the collimator 14, the optical splitter 13 and the cylindrical lens 17, and are then received by the optical detector 18. The optical detector 18 converts the received return laser beams into electrical signals containing data stored in the optical disc, and servo signals for adjusting positions of the objective lens 16.

The optical pickup unit 10 also includes a base (not shown) for mounting the aforementioned optical components therein. The light source 11, the diffraction element 12, the optical splitter 13, the collimator 14, the reflector 15, the cylindrical lens 17 and the optical detector 18 are directly secured in the base, while the objective lens 16 is adjustably mounted to the base via a lens mounting structure 20 (shown in FIG. 2).

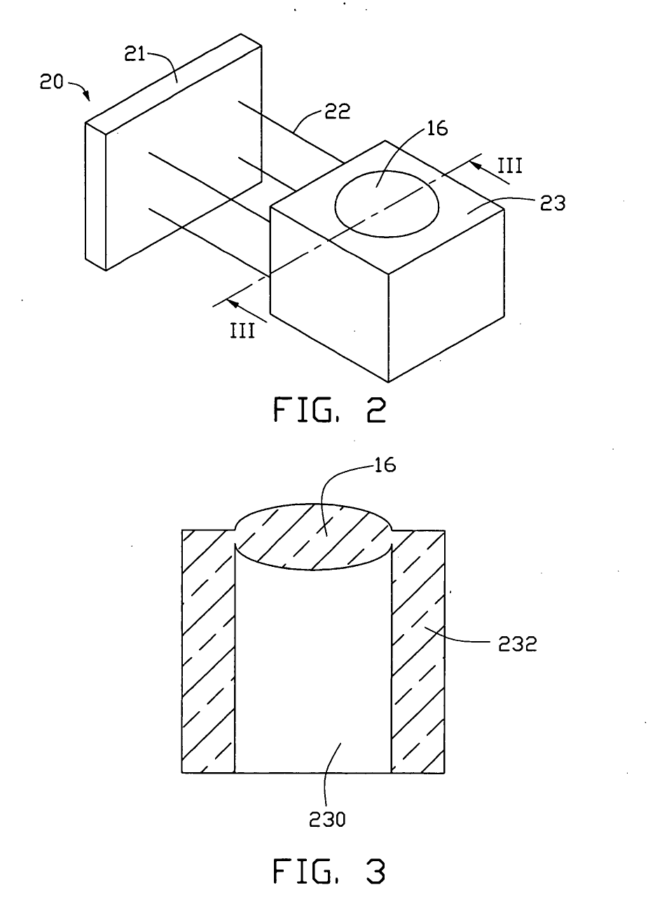

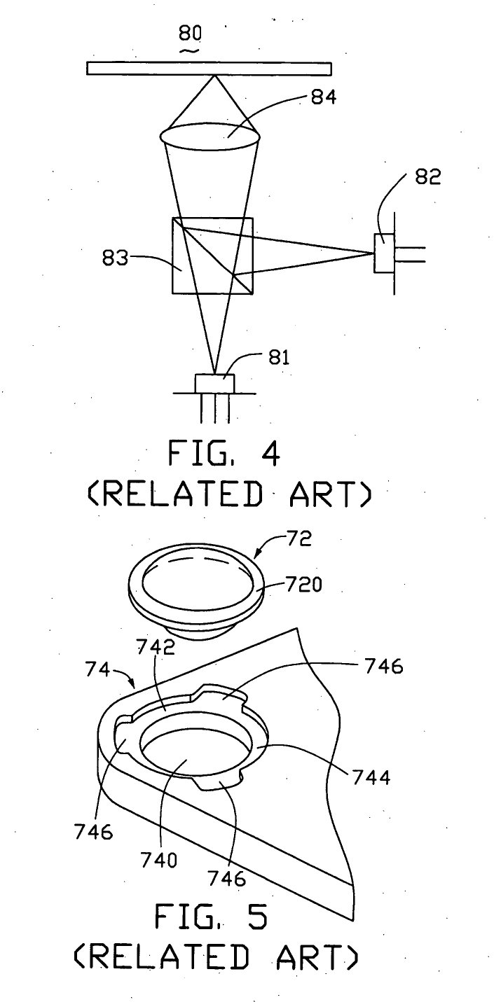

Referring to FIGS. 2 and 3, the lens mounting structure 20 includes a mounting wall 21 fastened to the base, a lens holder 23 for holding the objective lens 16, and restricting elements 22 interconnecting the mounting wall 21 and the holder 23. In the illustrated embodiment, the restricting elements 22 are four wires that are parallel to each other. One end of each wire 22 is fixed to the lens holder 23, while the other end of each wire 22 is fixed to the mounting wall 20. The lens holder 23 is suspended by a magnetic levitation device (not shown), and is horizontally and vertically movable. The movement of the lens holder 23 is restricted by the restricting elements 22.

The lens holder 23 includes a chamber 230 bounded by four sidewalls 232. The objective lens 16 is formed on the lens holder 23, with at least part thereof being received in the chamber 230. A width of the chamber 230 is slightly greater than that of a working aperture of the objective lens 16. Thus, the parallel light beams incident on the objective lens 16 can pass through the chamber 230 without being blocked. The overall size of the optical pickup unit 10 can also be minimized.

The objective lens 16 and the lens holder 23 are integrally formed together by injection molding. In the illustrated embodiment, the lens holder 23 is integrally formed with the optical element. In an alternative embodiment, the combination of the objective lens 16 and the lens holder 23 can be obtained by insert molding, with the objective lens 16 being preformed. In either case, because the combination of the objective lens 16 and the lens holder 23 is obtained by an injection molding process or an insert molding process, there is no need to employ an adhesive. The above-mentioned problems of the background art caused by adhesive are therefore avoided. That is, optical aberrations caused by contamination or deflection or displacement of the objective lens can be avoided. In addition, a structure of the combination of the objective lens and the lens holder is simplified, compared with the conventional structure of an objective lens and a lens holder. A size of the optical pickup unit may also be minimized accordingly. For obtaining better optical performance, the objective lens 16 and the holder 23 are preferably made of essentially the same material, such as SiO₂. Correspondingly, optical characteristics of the objective lens and the lens holder, such as refractive index, abbe number, etc., are similar.

It should be emphasized that the above-described embodiments are merely possible examples of implementation, merely set forth for a clear understanding of the principles of the invention. Many variations and modifications may be made to the above-described embodiments without departing substantially from the spirit and principles of the invention. All such modifications and variations are intended to be included herein within the scope of this disclosure and the present invention and protected by the following claims.

What is claimed is:

1. A combination of an optical element and a holder for holding the optical element, for use in an optical storage system, wherein:
the holder comprises a hole, and the optical element is integrally formed with the holder, with at least a portion of the optical element occupying part of the hole, and the optical element and the holder are formed of essentially the same material.

2. The combination in accordance with claim 1, wherein the holder is integrally formed with the optical element by an injection molding process.

3. The combination in accordance with claim 1, wherein the holder is integrally formed with the optical element by an insert molding process.

4. The combination in accordance with claim 2, wherein the optical element is a preformed lens, and the preformed lens is formed with the holder by the injection molding process.

5. The combination in accordance with claim 1, wherein the material of the optical element and the holder comprises SiO₂.

6. The combination in accordance with claim 1, wherein the hole has a diameter substantially equal to a working aperture of the optical element.

7. The combination in accordance with claim 1, wherein the optical element is an aspherical lens.

8. The combination in accordance with claim 1, wherein the optical element is a diffraction lens.

9. An optical pickup unit for an optical disk storage system, said optical pickup unit comprising:
a light source for generating a light beam;
a focus device, the focus device including an objective lens for focusing the light beam on an optical disk and a holder holding the objective lens, the objective lens and the holder being integrally formed together; and
an optical detector for receiving a return light beam reflected from the optical disk.

10. The optical pickup unit in accordance with claim 9, wherein the holder and the objective lens are formed of essentially the same material.

11. The optical pickup unit in accordance with claim 10, wherein the material comprises SiO₂.

12. The optical pickup unit in accordance with claim 9, wherein the holder is integrally formed with the optical element by an injection molding process.

13. The optical pickup unit in accordance with claim 9, wherein the objective lens is a preformed lens, and the preformed lens is integrally formed with the holder by an insert molding process.

14. The optical pickup unit in accordance with claim 9, wherein the holder has a hole, and at least a portion of the objective lens occupies part of the hole.

15. The optical pickup unit in accordance with claim 14, wherein the hole has a width greater than a working aperture of the objective lens.

16. An optical disk storage system comprising:
means for accommodating and operating an optical disk in said optical disk storage system; and
an optical pickup unit installed beside said means and capable of retrieving data from said accommodated optical disk in said optical disk storage system via light generated by said optical pickup unit, said optical pickup unit comprising an assembly integrally formed beside said accommodated optical disk to provide a path for said light to said accommodated optical disk, said assembly comprising a portion thereof functioning as an object lens of said optical pickup unit and another portion thereof having space therein as a part of said path, and said portion used as said object lens and said another portion of said assembly being made of same material.

17. The optical disk storage system in accordance with claim 16, wherein said another portion of said assembly is a holder of said portion used as said object lens and capable of holding said portion used as said object lens in position in said optical disk storage system.

18. The optical disk storage system in accordance with claim 16, wherein said space in said another portion of said assembly is formed in a chamber of said another portion, and a cross-sectional area of said chamber is larger than an occupying area of said portion used as said object lens.
